(19) United States
(12) Patent Application Publication
(10) Pub. No.: US 2007/0014647 A1
(43) Pub. Date: Jan. 18, 2007

(54) DEVICE FOR SUPPLYING A TOOL ROTATING OR ROTATABLE ABOUT AN AXIS OF ROTATION FOR MACHINING MATERIALS WITH A COOLANT AND/OR LUBRICANT

(75) Inventors: Ruediger Watzke, Speikern (DE); Peter Liebald, Hilpolstein (DE)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: EMUGE-Werk Richard Glimpel GmbH & Co. KG Fabrik fur Prazisionswerkzeuge, Lauf (DE)

(21) Appl. No.: 11/424,986

(22) Filed: Jun. 19, 2006

(30) Foreign Application Priority Data
Jul. 14, 2005 (DE) 20 2005 011 271.2

(51) Int. Cl. B23Q 11/10

(52) U.S. Cl. 409/136

(57) ABSTRACT

A device for supplying coolant and/or lubricant to a rotating/rotatable tool includes a flow duct with an interior space through which the coolant and/or lubricant can flow, and which can be coupled to a tool's flow duct and a seal between the two flow ducts. The seal can be made of a material that is of a higher elasticity than the material of the device's flow duct and the tool's flow duct. As such, the seal also has a high durability for the coolant and/or lubricant. The seal can be configured to bear against at least one surface of the device's flow duct and against at least one surface of the tool to prevent leakage of the coolant and/or lubricant as the coolant and/or lubricant passes from the device's flow duct into the tool's flow duct. Further, a device is disclosed for coupling the tool to the device that supplies the coolant and/or lubricant.

### CROSS-REFERENCE TO RELATED APPLICATIONS

The present invention claims the benefit of priority under 35 U.S.C. § 119 to German Patent Application No. 20 2005 011 271.2, filed on Jul. 14, 2005, having a translated title of “Device for Supplying a Tool Rotating or Rotatable About an Axis of Rotation for Machining Materials With a Coolant and/or Lubricant,” which is incorporated herein by reference in its entirety.

### BACKGROUND OF THE INVENTION

1. The Field of the Invention

The present invention relates to a device for supplying a tool rotating or rotatable about an axis of rotation for machining materials with a coolant and/or lubricant.

2. Background and Relevant Art

Various devices have become known for coupling rotating tools (rotary tools) for machining materials, specifically drilling tools, threading tools and milling tools, to a tool spindle or drive shaft, for example from the “Handbuch der Gewindetechnik und Frästechnik” (Manual of Thread Technology and Milling Technique), edited by EMUGE-FRANKEN, published by Publicis Corporate Publishing, year of publication: 2004 (ISBN 3-89578-232-7), hereinafter simply referred to as “EMUGE Manual.” Examples of devices for coupling rotary tools include collet chucks and quick-change chucks used for cutting, milling, forming or grooving tools, in particular respective threading tools.

In chip removing or non-cutting or non-chip-removing machining of work pieces with such rotary tools, it is mostly necessary that a coolant and/or lubricant is supplied during the machining operation for cooling and/or lubrication. In view of the great variety of machining methods in threading, drilling, and milling technology, the used coolants and/or lubricants are required to satisfy very different requirements. In combination with wastes and other environmental factors, which are caused by their application, coolants and/or lubricants are of a predominant importance in relation to environmental relevance all over the large field of materials machining, and metal machining in particular. Examples of coolants and/or lubricants (“lubricoolants”) are oil-in-water emulsions, which can be required, however, in comparatively large quantities of approximately 2,400 liters per hour, such as, in conventional cooling and lubricating systems.

One possibility to reduce the problems linked up with the application of lubricoolants is lubrication with minimum quantities (MMS). With the MMS technique, the coolant and/or lubricant is/are mixed with air and arrive(s) in the form of an aerosol on the point of action of the tool and the work piece. In contrast with conventional cooling and lubrication, the MMS technique typically uses only roughly 6 to 100 milliliters (ml) of lubricoolant per hour. The supply of the aerosol to the point of action can take place from the outside (external MMS) or through the tool (internal or inner MMS).

With external supply, the tool is wetted via externally mounted spraying nozzles. The aerosol is mostly produced in the nozzle directly and the oil droplets are accelerated, with or without assistance by air, in a direction towards the tool. With internal supply, the aerosol consisting of air and the lubricoolant is supplied through the tool and is produced with the assistance of compressed air. Various structural designs of internal MMS systems are available, which are distinguished by the location where the aerosol is produced. One possibility of aerosol production is spraying or atomization and processing in a separate reservoir with subsequent conveyance of the aerosol through a pipe to the spindle head.

The supply to the point of action is realized through a rotary passage suitable for minimum quantities, through the spindle, the clamping or chuck system and eventually through the tool. More advanced MMS systems are based on the principle of aerosol production on the spindle head directly, or of a relocation of the spraying means into the spindle, directly ahead of the tool clamping or chuck system. With all internal MMS systems, structural measures must be taken in order to avoid segregation or breakdown of the aerosol during supply, e.g. by avoiding projecting edges, abrupt changes of cross-section, narrow radii or dead volumes hampering the aerosol flow. Flow characteristics without interference as far as possible must also be ensured on the side of the tool and the receiving component.

For this reason, tool manufacturers offer tools and tool-receiving components that are specifically matched with the requirements specified for MMS technology (Emuge Manual, pages 154 and 155). A known MMS tapping chuck comprises a collet chuck-receiving element for a collet chuck which, in its turn, accommodates the tool that presents an internal central coolant passage in the shank. A flow passage configured as a flow pipe (“coolant pipe”) and having a wide inlet for flow-optimized guidance of the lubricoolant up to the internal flow duct of the tool is supported in a hollow-shank cone (HSK) coolant pipe.

The HSK coolant pipe, in turn, reaches into the HSK-receiving element to which the lubricoolant is supplied in the axial direction. There, particularly the interface between the pressurized supply duct and the coolant pipe in the spindle in the connecting zone with the chuck shank, and moreover the interface between the coolant pipe and the interior flow duct in the tool, are mentioned as critical MMS segregation zones.

The flow pipe is now bearing by the front end of its wall against the front end of the tool shank in planar contact so that a sealing effect is achieved all around the flow communication. In order to improve the tightness at the connecting area even more the flow pipe is resiliently supported and pressed under spring pressure onto the front end of the tool shank. In practical operation, this feature yields good success and realizes well usable MMS systems. Despite the planar contact of the front end of the wall of the coolant pipe against the front end of the shank of the tap, some aerosol, air, or lubricoolant can yet leak out at the interface between the flow pipe and the tool in isolated cases. One of the possible causes of this leakage is attributable to roughness on the surface at the planar connecting area or even tolerances in manufacture.

### BRIEF SUMMARY OF THE INVENTION

One of the objects of the present invention, therefore, is to reduce or eliminate the leakage of aerosol, air, and lubricoolant from between the wall of the coolant pipe and the front end of the shank of the tap. In one embodiment of the invention, for example, at least one seal is provided at the interface between the flow passage and the tool, where the interior flow pipe volume is coupled to a tool flow pipe of the tool. The seal can be made of a material that allows for a compensation of superficial roughness and tolerances while it realizes a sealing bearing contact against the wall of the flow duct and the surface of the tool.

In one embodiment, a device is proposed for supplying a tool rotating or rotatable about an axis of rotation for machining materials with a coolant and/or lubricant, which comprises a flow duct having an interior duct space or volume enclosed by a wall for guiding, or allowing passage of, the coolant and/or lubricant. The interior duct space of the flow duct can be coupled, or adapted for being coupled, in fluidic terms, to at least one tool flow duct of the tool. In particular, the interior duct space can be brought into fluid communication (or a fluid connection) therewith, and the interior duct space comprises also at least one seal that consists of a material of higher elasticity, or which yields with higher elasticity, than that of the materials of the wall of said flow duct and the tool in the region of said tool flow duct.

Such material presents a high durability or resistance to the coolant and/or lubricant. In addition, when the interior duct space of the flow duct is coupled to the tool flow duct, the material bears against both the wall of said flow duct and against a surface of the tool with a sealing effect by at least one respective continuous, closed, or simply connected peripheral sealing surface around the interior flow volume of the flow duct and/or the tool flow duct.

The resilient seal can adapt itself to the sealing surfaces even at non-planar surfaces or to deviations created by tolerances, moreover ensuring a planar continuous tight sealing contact on account of the elastic resetting forces. Due to the improved sealing at the flow duct interface, this device is particularly well suitable for supplying the tool with aerosol and/or for lubrication with minimum quantities.

These and other objects and features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates a partly sectional side view of a tool chuck with a received rotary tool that is coupled via an interface with a seal to a central lubricant pipe;

FIG. 2 shows an enlarged sector at the point identified by “x” in FIG. 1 for illustration of the interface between the lubricant pipe and the tool shank with the seal;

FIG. 3 is a longitudinal sectional view of an interface between a lubricant pipe and a tool flow duct with a sealing ring in the tool shank;

FIG. 4 shows another embodiment of an interface between a lubricant pipe and a tool flow duct with a conical seal; and

FIG. 5 illustrates another embodiment of an interface between the lubricant pipe and the tool flow duct with a sealing sleeve inserted into the tool shank.

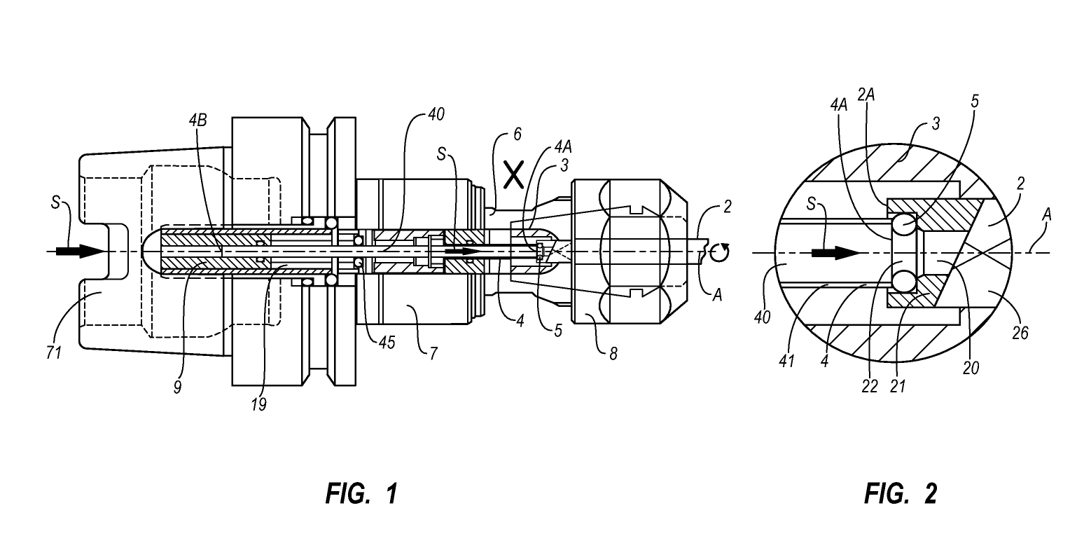

The Figures are only schematic illustrations. Parts and magnitudes corresponding to each other are identified by the same reference numbers in FIGS. 1 through 5.

### DETAILED DESCRIPTION OF THE PREFERRED EMBODIMENTS

In implementations of the present invention, it is generally preferred that the seal consists substantially of a synthetic material, preferably an elastomer or an elastomer compound or mixture. In one implementation for example, preferred elastomers are natural rubbers and/or synthetic rubbers which are preferably reticulated. Synthetic rubbers can be generally linear polymers or chain-type polymers that are reticulated by vulcanization or wide-mesh reticulation, thus obtaining soft flexible properties. Either saturated (in particular, so-called M-elastomers) or non-saturated (so-called R-elastomers) synthetic rubbers and elastomers can be employed. Thermoplastic elastomers (TPE) are preferably used, which are suitable for forming and are therefore particularly easy to process and friendly in recycling.

Some examples of suitable elastomers can be as follows:
butadiene elastomers (BR)
styrene/butadiene elastomers (SBR)
acrylonitrile/butadiene elastomers (NBR)
isoprene elastomers (IR, NR)
isoprene/isobutylene copolymers (butyl rubber)
vinyl elastomers, in particular ethylene-vinyl acetate polymers (EVA) and copolymers (EVAC)
ethylene propylene copolymers (EPDM, EPM)
acryl rubber (ACM)
polyisobutylene (PIB)
urethane rubber (PUR)
siloxane elastomer (SI), which is generally composed of reticulated polysiloxanes or polysiloxane compounds and/or of macro molecules with a continuous concatenation of silicon atoms and oxygen atoms.

A preferred siloxane elastomer is a siloxane rubber (SIR, siloxane rubber), also referred to as silicone rubber, or briefly, silicone. A siloxane rubber is generally composed of reticulated high-molecular polydimethyl siloxanes (Q), wherein one fraction of the methyl group can be substituted by phenyl groups (PMQ) or vinyl groups (VMQ).

In one embodiment, the seal bears against the sealing surface, the wall of said flow duct, and a surface of the tool at a predetermined application pressure and/or with elastic deformation, preferably by means of at least one application means that comprises at least one spring in particular, and presses the flow duct against the seal at the application pressure. The seal can then be held or fastened at the flow duct at the wall thereof, for instance by adhesive bonding or clamping.

In an alternative embodiment, the seal can be in a receiving space in the tool. Even though each tool can be modified in a corresponding manner, here an advantageous structure can be achieved that is well suitable even with different diameters of the tool. The receiving space in the tool can have a cylindrical or conical configuration in particular. The receiving space of the tool is generally connected to the tool flow duct or constitutes a connecting zone between the interior flow volume of the flow duct and the tool flow duct.

The seal bears preferably against an inner side of the receiving space and/or is adapted at least to the outside of the shape of the inner side of the receiving space. Preferred embodiments of the seal are a ring, particularly having a round cross-section, a sleeve or a bush, specifically in the form of a hollow cylinder, or a hollow conical segment. Moreover, the seal can also present a more complex sealing profile, preferably also at least one protruding sealing lip for sealing and/or at least one groove or annular groove for accommodating the wall of the flow duct at the front end thereof.

Even when the seal can be fundamentally disposed for rotation relative to the tool or the flow duct, it is yet preferred that it is connected for rotation along with the surface of the tool, particularly the inner side of the receiving space and/or the wall of the flow duct. This connection is preferably established by an adhesive bond and/or by a shape-locking and/or frictional and/or positive and/or force-locking connection. Moreover, the seal can also be applied as a viscous sealing compound on the surface of the tool, particularly the inner side of the receiving space, and/or on the wall of the flow duct, at least in the region of their front end, with subsequent curing or solidification. When the interior flow volume of the flow duct is coupled, the seal can tightly bear against the wall of the flow duct at least at its front end and/or at least on its inside and/or at least on its outside.

The device for supplying the tool with coolant and/or lubricant is preferably used in a device for coupling a tool rotating or rotatable about an axis of rotation for machining materials and having a drive shaft, comprising a first holding means including a tool-receiving space for receiving the tool, with a terminal position, or end position, for the tool within the tool-receiving space, and a second holding means connected or adapted for connection to the drive shaft in a coupling zone and comprising a receiving space for receiving the first holding means.

The collet chuck-receiving element 6 can be supported as chuck body in a chuck shank 7 and coupled to the latter for rotation therewith, with the possibility to provide an axial compensation device with restoring spring for compensating axial displacements of the tool 2 in the work piece, which compensates a corresponding axial displacement of the chuck body relative to the chuck shank 7. In the illustrated embodiment, the chuck shank is configured as HSK shank including a connecting space 71 on that end of the chuck shank 7, which can be turned away from the chuck body 6 and in which the tool spindle (not illustrated here) can engage and can be clamped or fastened in any other way in a frictional and/or positive manner with coupling for rotation therewith. The collet chuck 3 can be frictionally clamped in the collet chuck-receiving element 6 by means of a collet chuck nut 8 that can be screwed on at the front end. With this configuration, the shank 21 of the tool 2 is equally frictionally clamped in the collet chuck 3 and locked in the axial direction towards the axis of rotation A.

A lubricant pipe 4 can extend through the chuck body 6 and the chuck shank 7 coaxially or axially-centrally relative to the axis of rotation A and can be supported by its end 4B opposite to the end 4A coupled to the tool 2 in a lubricant pipe 9 of a major diameter. The interior volume of the lubricant pipe 9 can be in flow communication with the inner volume 40 of the lubricant pipe 4. The inner flow volume 90 of the lubricant pipe 9 can open into the inner flow duct of the tool spindle (not illustrated here) when the tool spindle is engaged in the connecting space 71 of the chuck shank 7. As a result, it is possible to pass a lubricant, specifically in the form of an aerosol, as part of a lubrication system with minimum quantities (MMS) up to the operating range of the tool 2 (not shown here), within which the tool 2 machines the material or the work piece. This can be done by passing the lubricant through the lubricant pipe 9, then through the lubricant pipe 4 to the interface at the end 4A of the lubricant pipe 4. From there the lubricant can reach the inner tool flow duct 20 of the tool 2 and can then proceed to the operating range of the tool 2.

The lubricant S is preferably present in the form of an aerosol that can be produced by mixing compressed air with an oil emulsion and that can be supplied via the tool spindle into an inner supply passage in the coolant pipe 9 according to FIG. 1. In such a system, it is possible to provide a common lubrication with minimum quantities (MMS) wherein only very slight quantities of typically about 20 ml to about 50 ml per hour of the lubricant or oil proper are supplied in the aerosol, such as in the form of oil droplets or lubricant droplets in the air.

The tool 2 can be a milling, drilling, or threading tool, such as a tap, a thread-milling tool or a cold-forming tap, particularly a circular forming tap or a thread-forming screw. At the interface between the lubricant pipe 4 and the tool 2, now a seal 5 is provided, which can be configured as continuous peripheral sealing read in the embodiment according to FIG. 1 and FIG. 2. The seal 5 is disposed in an appropriate receiving space 22 of the tool 2 on that tool front end 2A, which faces the coolant pipe 4. The seal 5 can be adhesively bonded in the receiving space 22 to the wall of the shank 21 and/or it can be inserted into the shank in a frictional and/or positive manner, in particular.

The lubricant pipe 4 can be pressed against the sealing ring 5 by the front end of the wall 41 at the end 4A by means of a spring means, particularly a helical spring, and by a collar 45 on the pipe so as to ensure a reliable tight sealing in order to prevent the lubricant aerosol from leaking out of the inner pipe volume 40 or the receiving space 22 as well as from the tool flow duct 20.

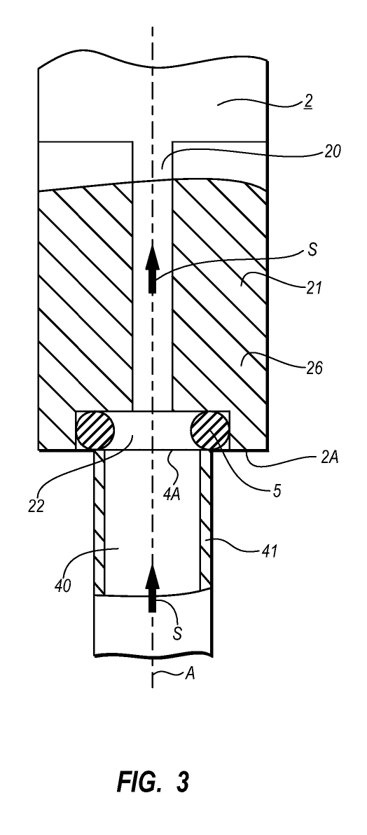

FIG. 3 illustrates a similar embodiment of a sealing provision with a sealing ring having a circular cross-section in the non-deformed condition, or an “O-ring” such as that shown in FIG. 2.

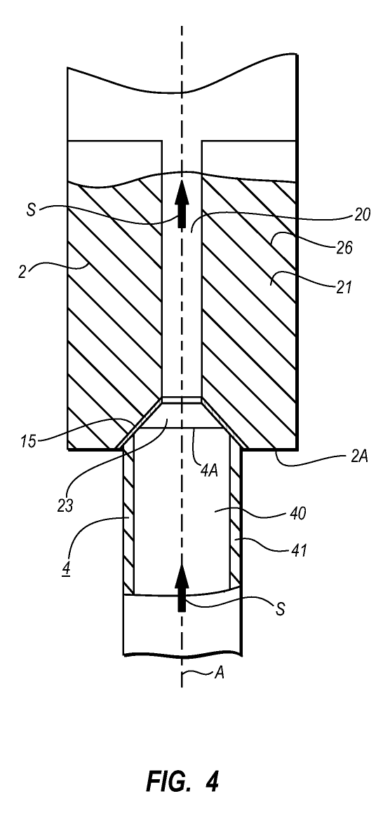

In the embodiment according to FIG. 4, a receiving space 23 is formed in the shank 21. The diameter of the receiving space 23 tapers inwardly from its widest diameter or cross-section at the front end 2A to a smaller diameter or cross-section at the inner tool flow duct 20. The receiving space 23 is, therefore, reduced in the manner of a cone and/or is configured sunk chamfer. A seal 15 is applied in the form of a sealing compound (e.g., a silicone compound) on the inside of this conical receiving space 23, which, when curing, becomes bonded to the shank. The front face of the wall 41 of the coolant pipe 4 at the end 4A now bears against this sealing compound of the seal 15. To this end, the outside opening or the widest cross-section of the receiving space 23 is chosen to be wider than the outside cross-section of the lubricant pipe 4 so that the lubricant pipe 4 is tightly adhered to the sealing compound or the seal 15 in an interior section.

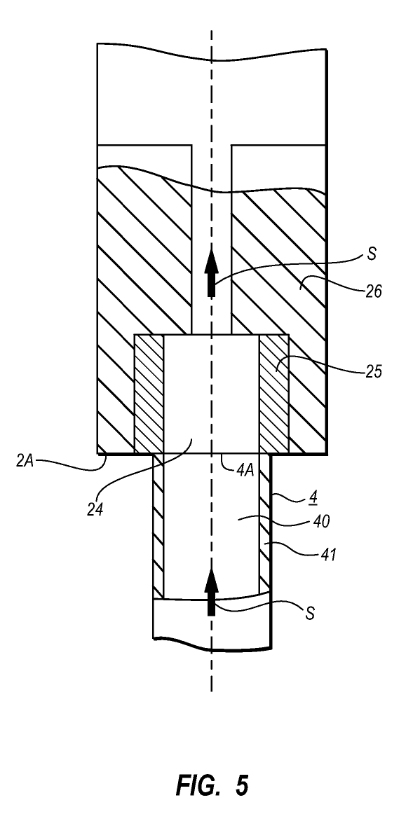

In the embodiment according to FIG. 5, a rather deep receiving space 24 is formed in the shank 21 of the tool 2, in which a sealing sleeve or sealing bush is inserted. The sealing sleeve or bush is configured, in particular, in the manner of a hollow cylinder, like the receiving space 24. The sealing sleeve can be fastened in a frictional and/or positive manner, or also by adhesive bonding. The inner diameter of the sealing sleeve 25 corresponds to the diameter of the inner tool duct 20, while the front end of the wall 41 of the lubricant pipe 4 bears equally against the cylindrical front end of the wall 41.

The end 4A of the coolant pipe 4 according to FIG. 4 is disposed inside the recess or the receiving space 23 in the tool 21, while in the embodiments according to FIG. 3 and FIG. 5 it bears against the front end 2A of the tool shank 21 on the respective seal 15 or 25, respectively, so as to be flush therewith.

It is also possible to use other sealing sections both as prefabricated elements and as parts applied only in the receiving space in the tool shank, instead of the seal embodiments illustrated in FIGS. 2 to 5. It is possible, for instance, to use sealing sections that are additionally improved in view of the sealing area or the tight sealing effect and that present sealing lips. For example, sealings which project beyond the front end of the wall of the lubricant pipe and also partly cover the inside and/or outside lateral wall of the wall 41. In particular, the wall 41 can be accommodated in a peripheral annular groove in the seal or an annular sealing lip can bear against the outside of the wall 41, for instance. Such sealing sections are easy to produce by such methods as injection molding.

Any soft synthetic resins resistant to the lubricant S can be used as materials for the seal, such as, for example, elastomers such as silicone rubber or siloxane elastomers (SIR), or even other common elastomers. The lubricant S is passed along the direction illustrated in FIGS. 1 to 4 via the coolant pipe 4 through the inner pipe volume 40 into the tool flow duct 20 via the inner volume enclosed by the seal of the receiving space in the tool shank up to the point of action. The point of action is generally a discharge point within the operating range of the tool, for example at the operating head or within the cutting or shaping range.

The tool shank 21 can be positively connected to a corresponding square of the collet chuck 3 in the zone of a square 26 on the outside so as to be fixed and coupled for rotation therewith. It is also possible to provide another polygonal shape or a different positive connection for fixing the tool 2 in a defined angular position about the axis of rotation A in the tool-receiving element or the collet chuck 3.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

The Figures refer to various parts of the invention by number. The following list identifies parts in the Figures by corresponding number.
2 tool
2A front end
3 collet chuck
4 coolant or lubricant pipe
4A end of coolant or lubricant pipe
4B opposite end of coolant or lubricant pipe
5 seal
6 collet chuck-receiving element
7 chuck shank
8 collet chuck nut
9 coolant or lubricant pipe
15 seal
19 spring means
20 toolflowduct
21 toolshank
25 sealing sleeve
26 square
40 inner pipe volume
41 pipe wall
45 collar
71 connecting space
A axis of rotation

We claim:

1. A device for supplying coolant and/or lubricant to a tool that is configured for machining materials, wherein the tool is configured to rotate about an axis of rotation, comprising:
a flow duct having an interior duct space enclosed by a wall for guiding the coolant and/or lubricant, wherein the interior duct space is configured to be coupled to at least one tool flow duct of the tool; and
at least one seal comprising a material of higher elasticity than that of the flow duct wall and of the tool in the region of the tool flow duct, the at least one seal having high durability with respect to the coolant and/or lubricant;
wherein the at least one seal, when the interior duct volume of the flow duct is coupled to the tool flow duct, is configured to bear with at least one sealing surface against the wall of the flow duct and against a surface of the tool;
wherein the at least one sealing surface is configured to surround any one or more of the following completely or in a closed configuration:
(i) the interior duct space of the flow duct;
(ii) the tool flow duct; or
(iii) a connecting zone connecting the interior duct space and the tool flow duct.

2. The device as recited in claim 1, wherein the at least one seal is configured at its sealing surface to bear against the wall of the flow duct and against the surface of the tool at a predetermined pressing-on-pressure and/or with elastic deformation.

3. The device as recited in claim 1, further comprising at least one pressing-on-means configured to press the flow duct against the at least one seal at a pressing-on-pressure, wherein the pressing-on-means preferably comprises at least one spring.

4. The device as recited in claim 1, wherein the at least one seal is configured to be arranged in a receiving space of the tool, wherein the receiving space has one of a cylindrical configuration, or a conical configuration.

5. The device as recited in claim 1, wherein a receiving space of the tool is configured to one of:
(i) connect to the tool flow duct;
(ii) pass over into the tool flow duct; or
(iii) in the coupled condition, constitute a connecting zone between the interior duct space of the flow duct and the tool flow duct.

6. The device as recited in claim 1, wherein the at least one seal is configured to:
(i) bear against an inner side of a receiving space in the tool; and/or
(ii) adapt to the shape of the inner side of the receiving space at least at an outside portion of the at least one seal.

7. The device as recited in claim 1, wherein the at least one seal comprises any one or more of:
(i) a ring, in particular having a round cross-section;
(ii) a sleeve or bushing, in particular in the form of a hollow cylinder; or
(iii) a segment of a hollow cone.

8. The device as recited in claim 1, wherein the at least one seal comprises at least one protruding sealing lip.

9. The device as recited in claim 1, wherein the at least one seal comprises at least one groove for receiving the wall of the flow duct on a front end thereof.

10. The device as recited in claim 1, wherein the at least one seal is coupled to the surface of the tool, in particular the inner side of a receiving space of the tool and/or the wall of the flow duct, preferably by any one or more of:
(i) an adhesive bond;
(ii) a shape-locking joint; or
(iii) a force-locking joint.

11. The device as recited in claim 1, wherein the at least one seal is applied as a viscous sealing compound, which subsequently cure or solidifies, onto one or more of:
(i) the surface of the tool, in particular the inner side of a receiving space of the tool; or
(ii) the wall of the flow duct at least in the region of the front ends thereof.

12. The device as recited in claim 1, wherein, when the interior duct space of the flow duct is coupled, the at least one seal bears against the wall of the flow duct on one or more of:
(i) a front end of the flow duct;
(ii) an inner side of the flow duct; or
(iii) an outer side of the flow duct.

13. The device as recited in claim 1, wherein said seal consists essentially of an synthetic material and/or at least essentially of an elastomer or an elastic compound or mixture, comprising preferably any one or more of a siloxane elastomer, or a silicone rubber.

14. The device as recited in claim 1, wherein at least one of:
(i) the tool consists of a metal at least in the terminal zone or shank zone facing the flow duct;
(ii) the wall of the flow duct consists of a metal; or
(iii) the flow duct is a pipe having a substantially constant flow cross-section.

15. The device as recited in claim 1, wherein the coolant and/or lubricant is configured to be at least one of:
(i) water-free;
(ii) composed of at least one oil;
(iii) composed as an aerosol consisting at least essentially of air, liquid coolant and/or lubricant, and in particular at least one oil;
(iv) composed to lubricate the tool with minimum quantities; or
(v) composed to lubricate and/or cool the tool with less than about 100 ml per hour of coolant and/or lubricant supplied thereon.

16. A device having a drive shaft and configured to couple a tool for machining materials, wherein the tool is configured to rotate about an axis of rotation, comprising:
a first holding means including a tool receiving space for receiving the tool, the tool receiving space including a terminal position;
a second holding means configured to connect to a drive shaft in a coupling zone, the second holding means including a receiving space for receiving the first holding means; and
a means for supplying the tool with coolant and/or lubricant, preferably according to claim 1.

17. The device as recited in claim 16, further comprising a flow duct as part of the means for supplying the tool with coolant and/or lubricant, wherein any one or more of:
(i) the second holding means comprises at least one space formed between the coupling zone and the tool receiving space, such that when the flow duct is in a coupled condition, the flow duct extends at least from the terminal position to an interior of the coupling zone and bridges the at least one space;
(ii) the flow duct extends up into an interior of a duct in the drive shaft; or
(iii) the flow duct extends up to an interior of a coolant pipe in the second holding means while the coolant pipe extends up to the interior of the duct in the drive shaft.

18. The device as recited in claim 16, wherein at least one of:
(i) a tool shank of the tool is disposed, held, or clamped in the tool receiving space of the first holding means;
(ii) the coupling zone of a collet chuck of the second holding means comprises an interior coupling space as well as at least one coupler element; or
(iii) the first holding means is a clamping element or a collet chuck and the second holding means is a chuck

19. The device as recited in claim 16, wherein the means for supplying the tool with coolant and/or lubricant comprises:
a flow duct having an interior duct space enclosed by a wall for guiding the coolant and/or lubricant, wherein the interior duct space is configured to be coupled to at least one tool flow duct of the tool; and
at least one seal comprising a material of higher elasticity than that of the flow duct wall and of the tool in the region of the tool flow duct, the at least one seal having high durability with respect to the coolant and/or lubricant;
wherein the at least one seal, when the interior duct volume of the flow duct is coupled to the tool flow duct, is configured to bear with at least one sealing surface against the wall of the flow duct and against a surface of the tool;
wherein the at least one sealing surface surrounds any one or more of:
(i) the interior duct space of the flow duct;
(ii) the tool flow duct; or
(iii) a connecting zone connecting the interior duct space and the tool flow duct.
wherein, when the interior duct space of the flow duct is coupled, the at least one seal bears against the wall of the flow duct on one or more of:
(i) a front end of the flow duct;
(ii) an inner side of the flow duct; or
(iii) an outer side of the flow duct.
